(19) United States
(12) Patent Application Publication
(10) Pub. No.: US 2026/0287532 A1
(43) Pub. Date: Sep. 24, 2026

(54) RADIATIVE COOLING PERFORMANCE MEASURING DEVICE

(71) Applicant: KOREA INSTITUTE OF SCIENCE AND TECHNOLOGY, Seoul (KR)

(72) Inventors: Jin Hong KIM, Seoul (KR); Hyungduk Ko, Seoul (KR); Gumin Kang, Seoul (KR); Hyunho Park, Seoul (KR)

(21) Appl. No.: 19/349,633

(22) Filed: Oct. 3, 2025

(30) Foreign Application Priority Data
Mar. 18, 2025 (KR) 10-2025-0034806

(51) Int. Cl. G01N 25/18

(52) U.S. Cl. CPC G01N 25/18

(57) ABSTRACT

Provided is a radiative cooling performance measuring device including an insulation unit including a sample arrangement unit, a chamber on the sample arrangement unit, films interposed between the sample arrangement unit and the chamber, and a first gas injection unit connected to a region between the films, wherein an inner wall of the chamber has a hemispherical profile, and compressed dry air is provided to the region between the films through the first gas injection unit.

### CROSS-REFERENCE TO RELATED APPLICATION

This U.S. non-provisional patent application claims priority under 35 U.S.C. § 119 of Korean Patent Application No. 10-2025-0034806, filed on Mar 18, 2025, the entire contents of which are hereby incorporated by reference.

### BACKGROUND

The present inventive concept herein relates to a radiative cooling performance measuring device, and more particularly, to a radiative cooling performance measuring device capable of conducting standardized comparison of the characteristics of radiative cooling materials.

Radiative cooling (RC) technology is technology for lowering the temperature of a surface by reflecting sunlight and emitting heat in the form of an electromagnetic wave. The radiative cooling technology is economical and eco-friendly cooling technology since it is capable of cooling an internal space without consuming electricity. A typical radiative cooling performance evaluating device includes an acrylic chamber including a sample, and an insulation material for preventing thermal conduction between the acrylic chamber and the ground. In addition, in an outdoor environment in which sunlight is incident on the sample, the typical radiative cooling performance evaluating device measures a surface temperature of the sample and an internal space temperature of the acrylic chamber by using a thermocouple, and confirms a change in the surface temperature of the sample with respect to the internal space temperature of the chamber to evaluate radiative cooling performance.

When the radiative cooling performance evaluating device is used in an outdoor environment, variables such as the solar radiation, wind, humidity, and ambient temperature affect radiative cooling performance. Therefore, it is difficult to compare the performance of different radiative cooling materials and to standardize performance indicators.

### SUMMARY

The present inventive concept provides a radiative cooling performance measuring device which is easy to manufacture and has improved radiative cooling performance evaluation characteristics.

An embodiment of the inventive concept provides a radiative cooling performance measuring device according to a concept of the present includes an insulation unit including a sample arrangement unit, a chamber on the sample arrangement unit, films interposed between the sample arrangement unit and the chamber, and a first gas injection unit connected to a region between the films, wherein the inner wall of the chamber has a hemispherical profile, and compressed dry air is provided to the region between the films through the first gas injection unit.

In an embodiment of the inventive concept, a radiative cooling performance measuring device includes an insulation unit including a sample arrangement unit, a chamber on the sample arrangement unit, films interposed between the sample arrangement unit and the chamber, and a first gas injection unit connected to a region between the films, wherein the inner wall of the chamber has a hemispherical profile, and a cooling material provided between the inner wall and the outer wall of the chamber is further included, wherein the cooling material includes dry ice and isopropyl alcohol.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a perspective view of a radiative cooling performance measuring device according to an embodiment of the inventive concept;

FIG. 2 is a cross-sectional view of the radiative cooling performance measuring device according to the embodiment of the inventive concept;

FIG. 3A is a view illustrating a control sample according to an embodiment of the inventive concept;

FIG. 3B is a view illustrating a standard sample according to an embodiment of the inventive concept;

FIG. 4A is a graph showing the solar reflectance and the infrared emittance of a standard sample of the inventive concept;

FIG. 4B is a graph showing the surface temperature and the ambient temperature of the standard sample in a thermal equilibrium state;

FIG. 4C is a graph showing the difference between the surface temperature and the ambient temperature of the standard sample in a thermal equilibrium state;

FIG. 4D is a graph showing the ambient temperature of the standard sample according to a set temperature of a constant-temperature water bath;

FIG. 4E is a graph showing the correlation between the set temperature of the constant-temperature water bath and the ambient temperature of the standard sample;

FIG. 5 is a view illustrating a sample according to another embodiment of the inventive concept;

FIG. 6A is a graph showing the solar reflectance and infrared thermal radiation of samples of the inventive concept;

FIG. 6B is a graph showing the theoretical cooling performance of the samples of the inventive concept;

FIG. 6C is a graph showing the difference between the surface temperatures of the samples of the inventive concept and the ambient temperature of the samples;

FIG. 6D is a graph showing the temperature of the samples measured in an outdoor environment by using the radiative cooling performance measuring device according to the inventive concept; and

FIG. 6E is a graph showing average values of the temperature of the samples in an outdoor environment.

### DETAILED DESCRIPTION

In order to facilitate sufficient understanding of the configuration and effects of the inventive concept, preferred embodiments of the inventive concept will be described with reference to the accompanying drawings. However, the inventive concept is not limited to the embodiments set forth below, and may be embodied in various forms and modified in many alternate forms. Rather, the present embodiments are provided so that the disclosure of the inventive concept will be thorough and complete, and will fully convey the scope of the inventive concept to those skilled in the art to which the inventive concept pertains.

In the present disclosure, when an element is referred to as being on another element, it means that the element may be directly formed on another element, or that a third element may be interposed therebetween. Also, in the drawings, the thickness of elements is exaggerated for an effective description of technical contents. Like reference numerals refer to like elements throughout the specification.

Embodiments described in the present specification will be described with reference to cross-sectional views and/or plan views which are ideal illustrations of the inventive concept. In the drawings, the thickness of films and regions are exaggerated for an effective description of technical contents. Thus, the regions illustrated in the drawings have schematic properties, and the shapes of the regions illustrated in the drawings are intended to exemplify specific shapes of regions of a device and are not intended to limit the scope of the inventive concept. Although the terms first, second, third, and the like are used in various embodiments of the inventive concept to describe various components, these components should not be limited by these terms. These terms are only used to distinguish one element from another. The embodiments described and exemplified herein also include the complementary embodiments thereof.

The terms used herein are for the purpose of describing embodiments and are not intended to be limiting of the inventive concept. In the present specification, singular forms include plural forms unless the context clearly indicates otherwise. As used herein, the terms ‘comprises’ and/or ‘comprising’ are intended to be inclusive of the stated elements, and do not exclude the possibility of the presence or the addition of one or more other elements.

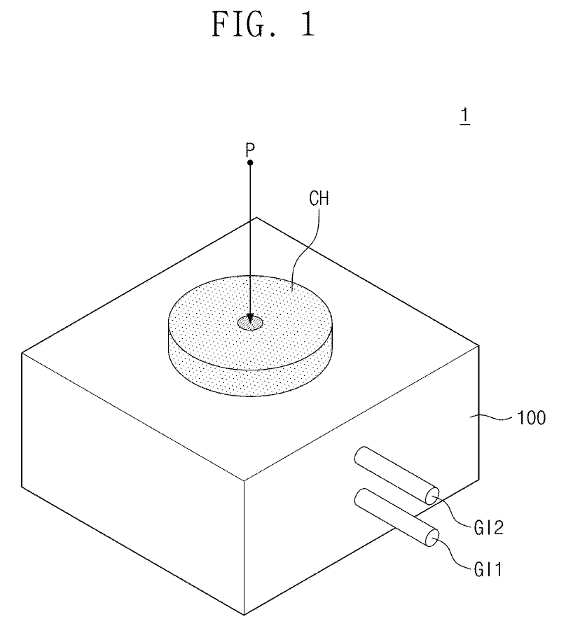

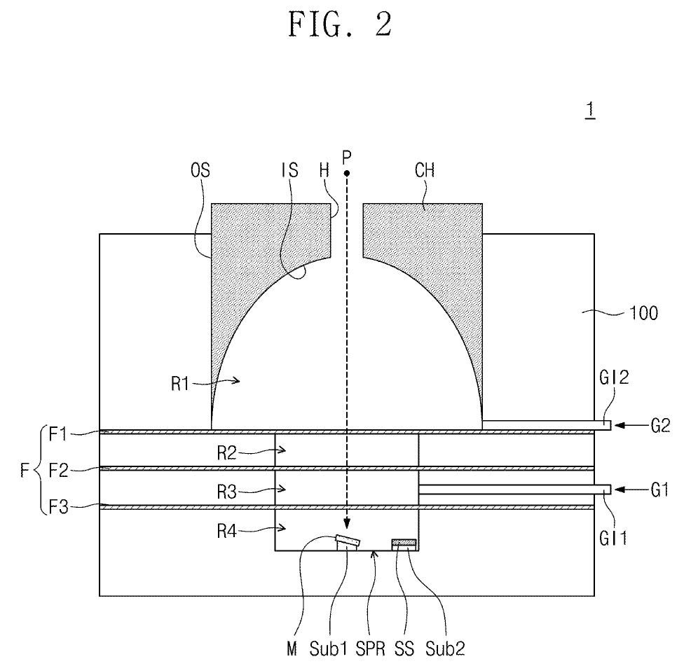

FIG. 1 is a perspective view of a radiative cooling performance measuring device according to an embodiment of the inventive concept. FIG. 2 is a cross-sectional view of the radiative cooling performance measuring device according to the embodiment of the inventive concept.

Referring to FIGS. 1 and 2, a sunlight simulation unit may be provided on a radiative cooling performance measuring device 1. The sunlight simulation unit may be a system for artificially reproducing sunlight. Light P simulated in the sunlight simulation unit may enter the radiative cooling performance measuring device 1. The sunlight simulation unit may include a light source and a sunlight simulation filter. The sunlight simulation unit may further include a lens, an optical fiber, an illumination system, a monitoring system, and the like, but is not limited thereto. For example, the sunlight simulation unit may include a light source and a sunlight simulation filter, but may not include a lens and an optical fiber.

The light source of the sunlight simulation unit may include at least one of a xenon (Xe) lamp, a mercury (Hg) lamp, a mercury-xenon (Hg-Xe) lamp, a tungsten halogen lamp, and a light emitting diode (LED). The sunlight simulation filter of the sunlight simulation unit may be at least one of an Air Mass (AM) 1.0G filter and an Air Mass (AM) 1.5G filter.

The radiative cooling performance measuring device 1 may include an insulation unit 100 and a chamber CH. The chamber CH may be provided in the insulation unit 100. The insulation unit 100 may surround the chamber CH. A portion of the chamber CH (e.g., an upper portion of the chamber CH) may be exposed by the insulation unit 100. An optical inlet H, which is an entrance through which the light P enters the chamber CH, may be provided on an upper portion of the chamber CH. The light P simulated in the sunlight simulation unit may be incident on a sample arrangement unit SPR, which is to be described later, through the optical inlet H. The insulation unit 100 may include an insulation material.

Gas injection units GI1 and GI2 may be provided on one side surface of the insulation unit 100. In some embodiments of the inventive concept, more gas injection units may be additionally provided. The gas injection units GI1 and GI2 may extend into the insulation unit 100 to provide compressed dry air into the chamber CH or a region between films F to be described later. The gas injection units GI1 and GI2 may be connected to a constant-temperature water bath. As a result, the compressed dry air heated in the constant-temperature water bath may be provided to the gas injection units GI1 and GI2.

The insulation unit 100 may include the sample arrangement unit SPR. The sample arrangement unit SPR may be a bottom surface of a recessed portion in a lower portion of the insulation unit 100. A sample substrate Sub1 may be provided on the sample arrangement unit SPR. The sample substrate Sub1 may be positioned in a middle portion of the sample arrangement unit SPR. A sample M, the radiative cooling performance of which is to be evaluated, may be disposed on the sample substrate Sub1. A thermocouple may be interposed on a bottom surface of the sample substrate Sub1. Light entered through the optical inlet H of the chamber CH may be incident on the sample M of the sample arrangement unit SPR.

A substrate Sub2 and a control sample SS on the substrate Sub2 may be provided at an edge spaced apart from the middle portion of the sample arrangement unit SPR. The control sample SS may be disposed in a region on which the light P is not directly incident. As a result, the control sample SS may not directly receive the light P. A thermocouple may be interposed on a bottom surface of the substrate Sub2. A surface temperature of the control sample SS may be measured using the thermocouple. The measured surface temperature of the control sample SS may be utilized as an ambient temperature of the sample M.

The chamber CH may be provided on the sample arrangement unit SPR. In cross-sectional view, an inner wall IS of the chamber CH may have a hemispherical profile. The inner wall IS of the chamber CH may face the sample arrangement unit SPR. The inner wall IS of the chamber CH may be a curved surface concave toward an outer wall OS of the chamber CH. The inner wall IS of the chamber CH may be connected to the optical inlet H. The inner wall IS of the chamber CH has a hemispherical profile, and thus may absorb a relatively large amount of radiant heat radiated from the sample M of the sample arrangement unit SPR. The outer wall OS of the chamber CH may include an insulation material and a reflective film. As a result, it is possible to minimize heat loss caused by conduction, convection, and radiation in the chamber CH.

The chamber CH may include at least one of metal, glass, and high-strength plastic. Specifically, the chamber CH may include plastic. For example, the chamber CH may include polylactic acid (PLA). The chamber CH may be black. The chamber CH may be manufactured by 3D printing using a 3D printer.

A cooling material may be provided inside the chamber CH. Specifically, the cooling material may be provided between the inner wall IS and the outer wall OS of the chamber CH. The cooling material may include dry ice and isopropyl alcohol. When liquid nitrogen is used as a cooling material, it may be difficult to store and use the liquid nitrogen. On the other hand, the cooling material of the inventive concept includes dry ice and isopropyl alcohol, which are easy to obtain, so that it may be relatively easy to store and use the cooling material. By the cooling material, a region inside the inner wall IS of the chamber CH may maintain a low temperature of about -60 °C to about -90 °C.

The films F may be interposed between the chamber CH and the sample arrangement unit SRP. The films F may extend parallel to a horizontal direction. The plurality of films F may be disposed to be spaced apart from each other in a vertical direction. For example, the films F may include a first film F1, a second film F2, and a third film F3. The first film F1 may be an uppermost film, and may be closest to the chamber CH. The third film F3 may be a lowermost film, and may be closest to the sample arrangement unit SPR. The second film F2 may be disposed between the first film F1 and the third film F3. The films F may be transparent. For example, the films F may include low-density polyethylene (LDPE). As another example, more films (e.g., a fourth film, a fifth film, ...) may be further provided.

Regions inside the radiative cooling performance measuring device may be defined by the films F. Specifically, a region between the first film F1 and the inner wall IS of the chamber CH may be a first region R1. A region between the first film F1 and the second film F2 may be a second region R2. A region between the second film F2 and the third film F3 may be a third region R3. A region between the third film F3 and the sample arrangement unit SPR may be a fourth region R4.

The first region R1 may have a hemispherical profile from a cross-sectional viewpoint. The second region R2, the third region R3, and the fourth region R4 may be surrounded by the insulation unit 100. The sample M and the control sample SS may be disposed in the fourth region F4. Light that has entered through the optical inlet H may pass through the first to third regions R1, R2, and R3 and be incident on the sample M of the fourth region R4. By providing the films F, it is possible to block external cold air and prevent heat transfer to the sample M caused by convection or conduction.

A first gas injection unit GI1 may be connected to the third region R3. Compressed dry air G1 may be provided to the third region R3 through the first gas injection unit GI1. The compressed dry air G1 may be heated in a constant-temperature water bath and provided through the first gas injection unit GI1. The provided compressed dry air G1 may be dried air from which moisture has been removed in order to prevent condensation into water vapor in the radiative cooling performance measuring device. A heating temperature of the compressed dry air G1 may be set by adjusting a set temperature of the constant-temperature water bath. The heated compressed dry air G1 may be provided to the third region R3, thereby changing the ambient temperature of the control sample SS and the sample M. As a result, the ambient temperature of the sample M may be adjusted to adjust the temperature of the compressed dry air G1.

A second gas injection unit GI2 may be connected to the first region R1. Compressed dry air G2 may be provided to the first region R1 through the second gas injection unit GI2. The compressed dry air G2 may be continuously provided to the first region R1. As a result, it is possible to prevent water drops from being formed due to condensation of moisture on the films F.

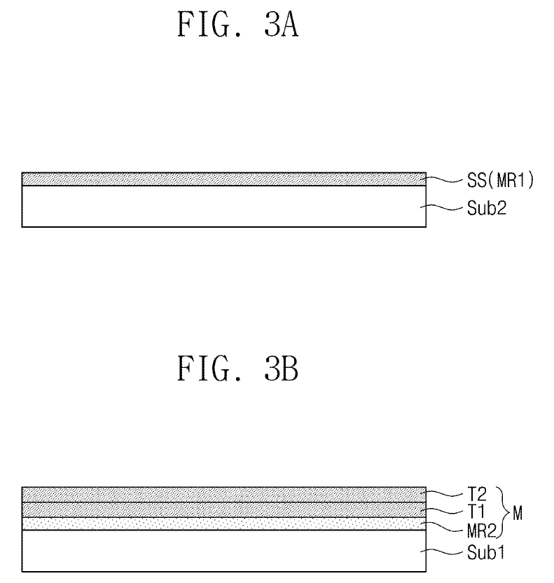

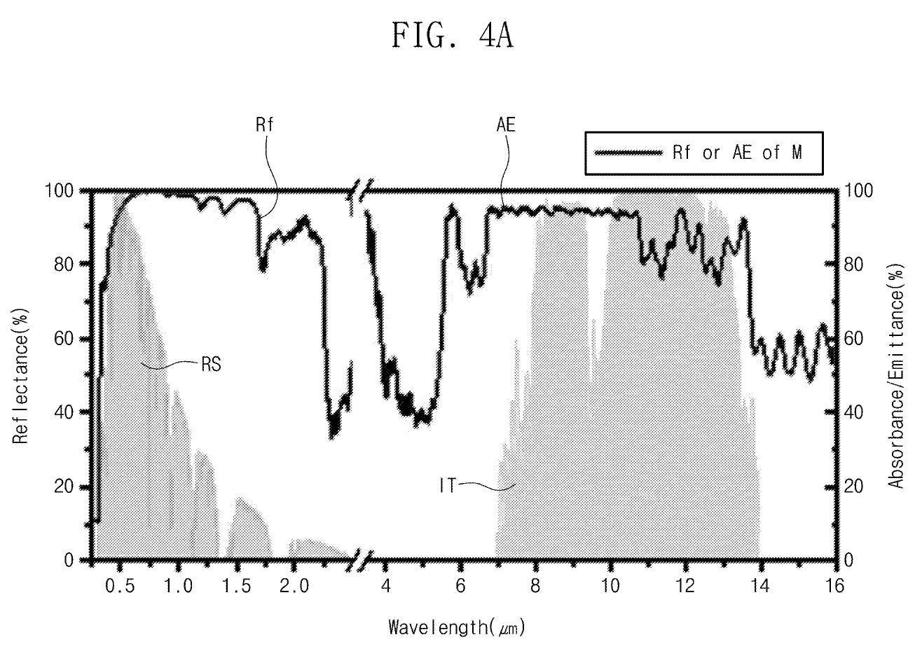

FIG. 3A is a view illustrating a control sample according to an embodiment of the inventive concept.

Referring to FIG. 3A, a control sample SS may be provided on a substrate Sub2. The control sample SS may include a control material MR1. The substrate Sub2 may have, for example, a horizontal length of 2.5 cm, a vertical length of 2.5 cm, and a thickness of 675 um, but is not limited thereto. The substrate Sub2 may be a silicon substrate.

The control material MR1 is a material serving as a comparison reference of a sample M, and may be a sample for measuring the ambient temperature of the sample M. Specifically, the control material MR1 may be a silver (Ag) mirror. The silver (Ag) mirror is disposed at an edge of the sample arrangement unit SPR, and thus may not directly receive light P. In addition, the silver mirror also reflects all the light P scattered inside a chamber CH, and thus may block the inflow of heat energy due to radiation. In particular, since the silver mirror has very low infrared (IR) emissivity, its own cooling effect by radiation may be negligible, which is highly advantageous for reflecting the actual internal temperature of the chamber (CH). By using a silver mirror as the control material MR1, it is possible to provide a control group sample having significantly high solar reflectance (e.g., 100%) and significantly low infrared emittance (e.g., 0%). The silver mirror has high thermal conductivity, and thus may maintain a temperature similar to the ambient temperature over time. A thermocouple may be attached to a bottom surface of the substrate Sub2 to measure the ambient temperature of the control sample SS and the sample M. The thickness of the silver mirror may be about 1 nm to about 5 um. For example, the thickness of the silver mirror may be 100 nm.

FIG. 3B is a view illustrating a standard sample according to an embodiment of the inventive concept.

A standard sample M according to FIG. 3B may be a sample to be evaluated for radiative cooling performance. Referring to FIG. 3B, for example, the standard sample M may include a silver mirror MR2 on a sample substrate Sub1 and adhesive materials T1 and T2 on the silver mirror MR2. The adhesive materials T1 and T2 may be transparent. For example, the adhesive materials T1 and T2 may be transparent tapes (e.g., Scotch tape).

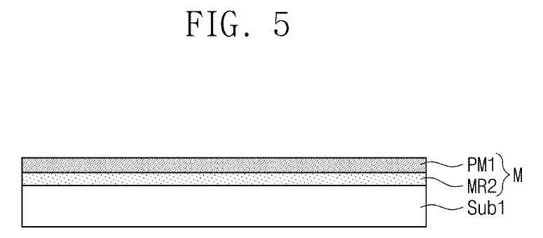

FIG. 5 is a view illustrating a sample according to another embodiment of the inventive concept.

Referring to FIG. 5, a sample M may further include a polymer PM1 on a silver mirror MR2. The thickness of the polymer PM1 may be greater than the thickness of the silver mirror MR2. The thickness of the polymer PM1 may be 1 um to 300 um, but is not limited thereto. Since the polymer PM1 is provided on the silver mirror MR2, the adhesive materials T1 and T2 of FIG. 3 may be omitted.

For example, the polymer PM1 may include at least one of polytetrafluoroethylene (PTFE, Teflon), polyvinylidene fluoride-hexafluoropropylene copolymer (PVDF-HFP), polypropylene (PP), polyvinylidene fluoride (PVDF), polymethyl methacrylate (PMMA), polyethylene (PE), polyurethane (PU), polystyrene (PS), polyamide (PA), polycarbonate (PC), polydimethylsiloxane (PDMS), and a cyclic transparent optical polymer (CYTOP).

A sample M according to the inventive concept is not limited to the standard sample M of FIG. 3B and the sample M of FIG. 5, and may include various samples. Specifically, various samples may be used as a sample to be evaluated for radiative cooling performance according to the inventive concept, and the standard sample M of FIG. 3B and the sample M of FIG. 5 are merely examples. Particularly, the standard sample M of FIG. 3B is easy to obtain ingredients thereof, and thus may be easy to prepare.

The radiative cooling performance measuring device according to the inventive concept may include a chamber CH having a hemispherical profile from a cross-sectional viewpoint. A plurality of films F spaced apart from each other in a vertical direction may be disposed between a sample arrangement unit SPR and the chamber CH. Heated compressed dry air may be provided to a region between the films F to adjust the temperature of the sample arrangement unit SPR. By adjusting the temperature of the sample arrangement unit SPR, it is possible to simulate an environment, which is similar to an outdoor environment, in the chamber CH.

Furthermore, the radiative cooling performance measuring device may be easily manufactured by 3D printing. In addition, a cooling material of the chamber CH may include dry ice and isopropyl alcohol. The dry ice and the isopropyl alcohol are easy to obtain, and are easy to store and use. As a result, it is possible to provide a radiative cooling performance measuring device which is easy to manufacture and has improved radiative cooling performance evaluation characteristics.

Hereinafter, Examples and Comparative Examples of the inventive concept will be described. However, the following Examples are only illustrative of the inventive concept, and the inventive concept is not limited the following Examples.

### Example 1: Preparation of standard sample

A silver mirror of 100 nm is attached on a silicon substrate having a size of 2.5 cm × 2.5 cm × 675 μm. A standard sample M is prepared by applying two layers of 3M’s Scotch tape on the silver mirror. This may be the standard sample M according to FIG. 3B.

### Experimental Example 1

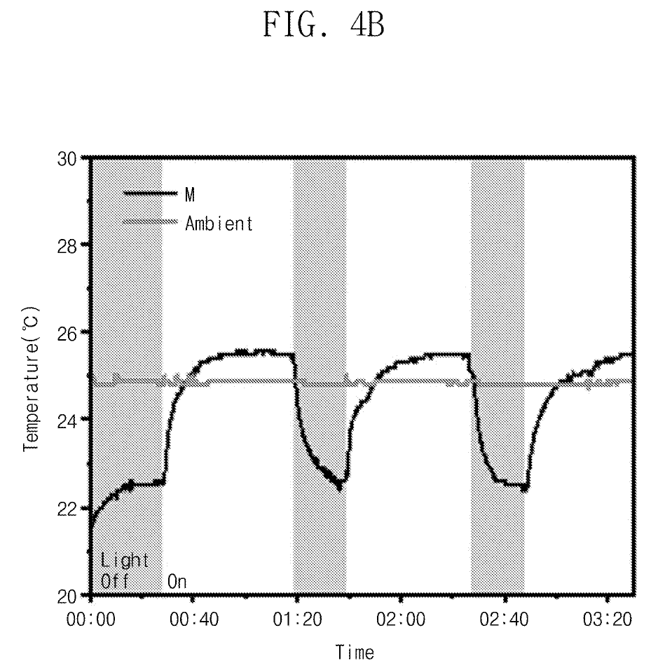

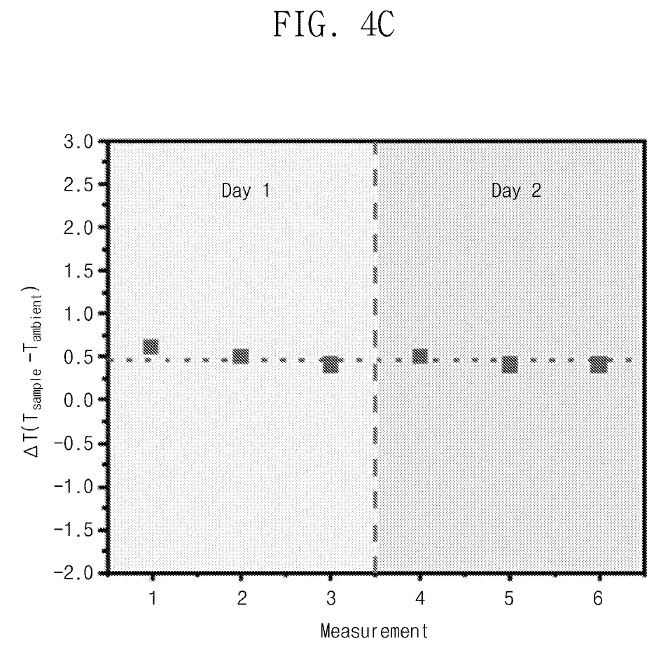

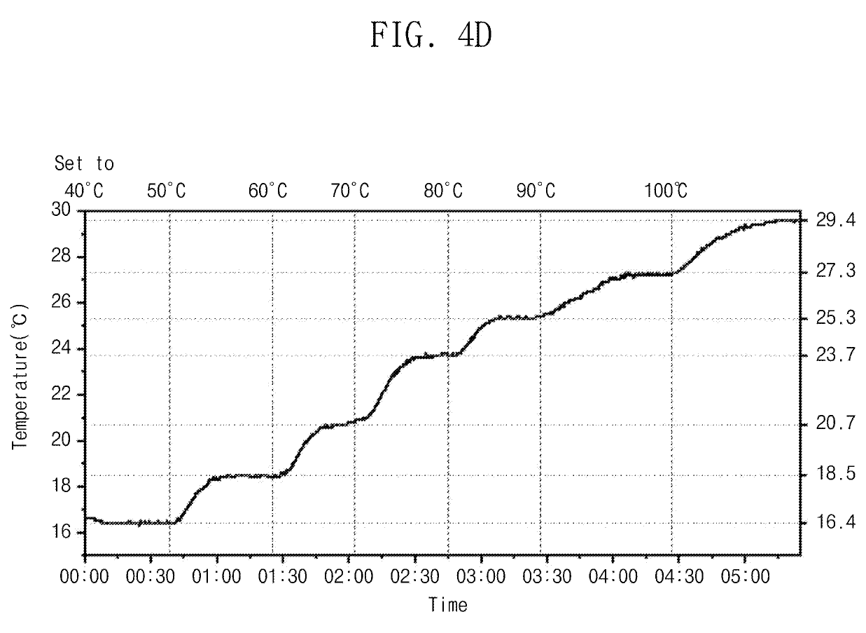

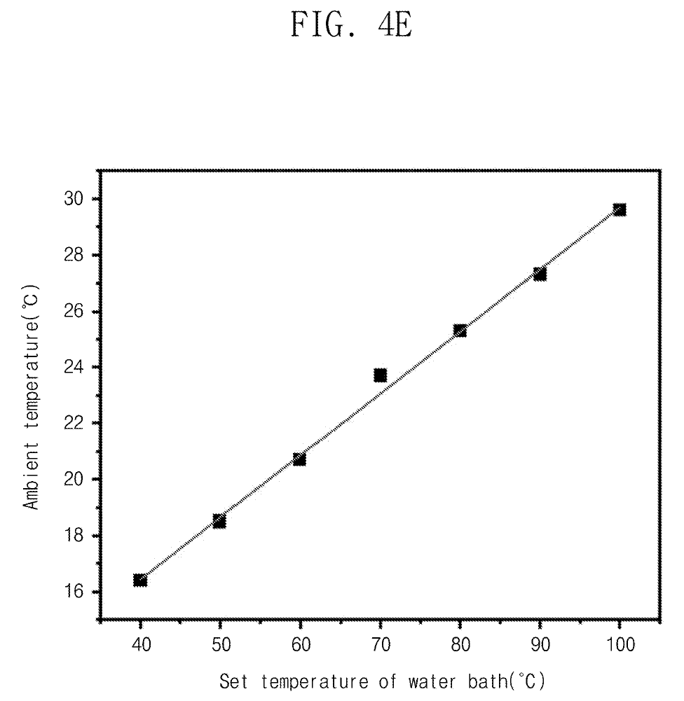

FIG. 4A is a graph showing measured optical properties of the sample according to Example 1. Specifically, it is a graph showing the solar radiation spectrum RS of the sample, the infrared transmittance IT of the atmosphere, the solar reflectance Rf and the infrared emittance AE of the sample. Referring to FIG. 4A, a graph (line) having a wavelength of less than 4 μm is the solar reflectance Rf of the sample M, and a graph (line) having a wavelength greater than 4 μm is the infrared emittance AE of the sample M. It can be seen that the solar reflectance Rf of the sample M is 95.4%, and the infrared emittance AE is about 88.0%, which are all high. This can be interpreted that the standard sample M reflects the light P incident on the sample arrangement unit SPR inside the chamber CH, and that the thermal energy emission by radiation is large. Accordingly, it is possible to compare various samples measured at different places with each other based on the standard sample M that is easy to prepare. In addition, it is possible to measure the ambient temperature more accurately using the control sample SS. The ambient temperature is the ambient temperature of the control sample SS and the standard sample M, and may be the temperature of the sample arrangement unit SPR.

### Experimental Example 2

FIG. 4B is a graph showing the surface temperature and the ambient temperature of the standard sample in a thermal equilibrium state. Referring to FIG. 4B, the standard sample M according to Example 1 was fixed on the sample substrate Sub1 of the sample arrangement unit SPR. Thereafter, the sample arrangement unit SPR was periodically irradiated with light three times through the optical inlet H, and when a thermal equilibrium state in which the surface temperature of the standard sample M was maintained constant was reached, the surface temperature of the standard sample M and the ambient temperature thereof were measured, respectively. As a result, it was confirmed that the difference between the surface temperature of the standard sample M and the ambient temperature was constant all of the three times.

### Experimental Example 3

FIG. 4C is a graph showing the difference between the surface temperature and the ambient temperature of the standard sample in a thermal equilibrium state. Referring to FIG. 4C, the surface temperature of the standard sample M was maintained an average of 0.47 °C higher than the ambient temperature, which was consistently observed in all three measurements. In three additional measurements performed on the next day (Day 2), the same average temperature difference as that of the previous day (Day 1) was shown, and a small standard deviation of 0.07 was observed. As a result, it can be confirmed that the radiative cooling performance measuring device according to the inventive concept is capable of accurately and consistently measuring the surface temperature of the standard sample M, and thus has excellent reproducibility.

### Experimental Example 4

FIG. 4D is a graph showing the ambient temperature of the standard sample according to the set temperature of a constant-temperature water bath. Referring to FIG. 4D, the ambient temperature of the standard sample M was measured by increasing the set temperature of the constant-temperature water bath connected to the first gas injection unit GI1 from 40 °C to 100°C at an interval of 10 °C. When the set temperature of the constant-temperature water bath was 40 °C, the thermal equilibrium was maintained at an ambient temperature of 16.4 °C. and when the set temperature of the constant-temperature water bath was 100 °C, the thermal equilibrium was maintained at an ambient temperature of 29.6 °C. Accordingly, it was confirmed that when the set temperature of the constant-temperature water bath increased, the ambient temperature of the standard sample also increased.

### Experimental Example 5

FIG. 4E is a graph showing the correlation between the set temperature of the constant-temperature water bath and the ambient temperature of the standard sample. Referring to FIG. 4E, it can be confirmed that the ambient temperature of the standard sample according to the set temperature of the constant-temperature water bath is very close to a linear trend line. As a result, it was confirmed that it was possible to adjust the ambient temperature of the standard sample by providing heated compressed dry air by adjusting the set temperature of the constant-temperature water bath. Furthermore, it was impossible to control the ambient temperature of the standard sample in an outdoor environment, whereas it was confirmed that the radiative cooling performance measuring device of the inventive concept had an effect of freely adjusting the ambient temperature of the standard sample.

### Example 2: Preparation of samples

A silver mirror of 100 nm is attached on a silicon substrate having a size of 2.5 cm × 2.5 cm × 675 μm. Samples M are manufactured by attaching polymer materials having a thickness of 100 um on the silver mirror. This may be the sample M according to FIG. 5. In the inventive concept, five kinds of polymer materials different from each other were used to prepare five kinds of samples M. The five kinds of polymer materials are respectively polyvinylidene fluoride-hexafluoropropylene copolymer (PVDF-HFP), polyvinylidene fluoride (PVDF), polymethylmethacrylate (PMMA), polydimethylsiloxane (PDMS), and a cyclic transparent optical polymer (CYTOP).

### Experimental Example 6

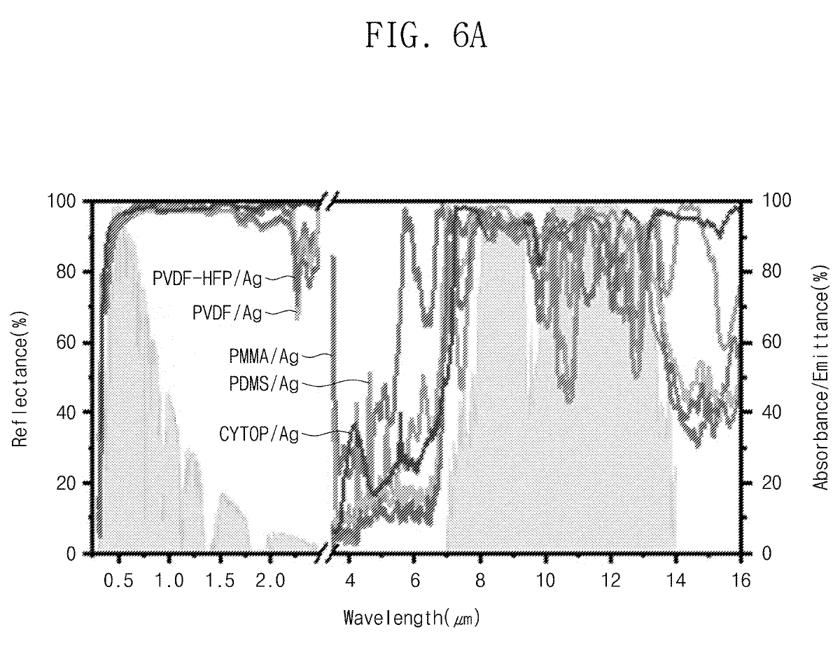

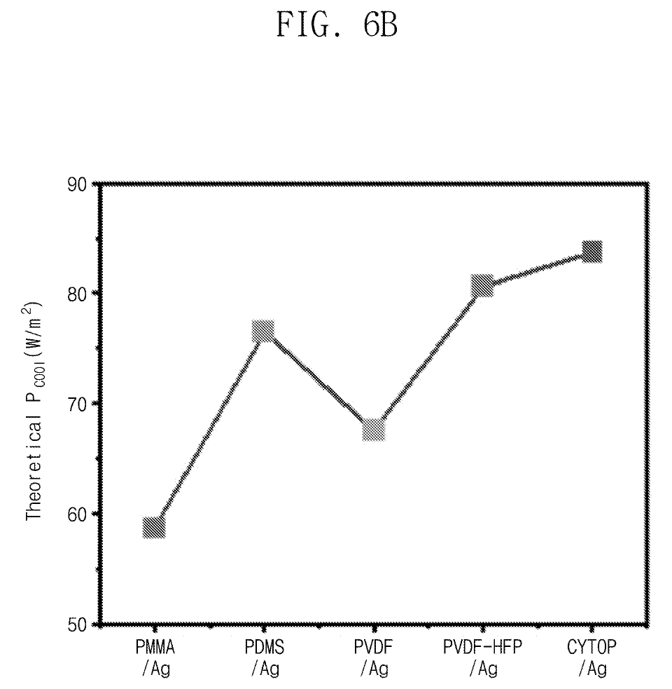

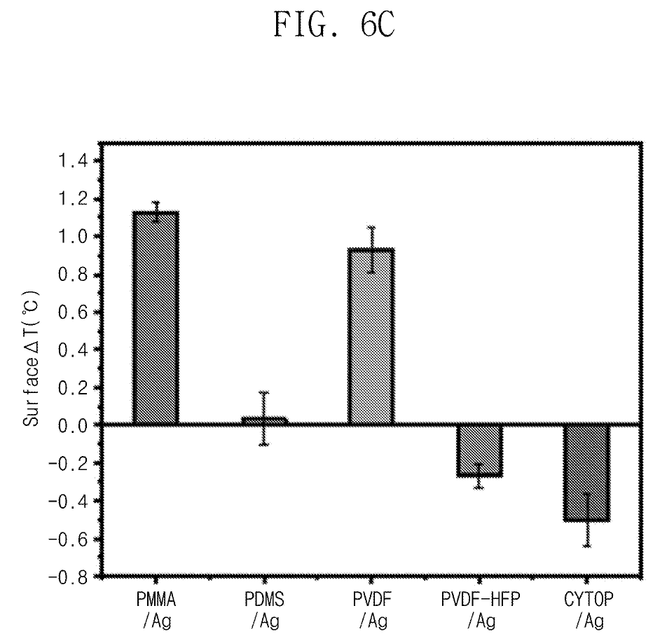

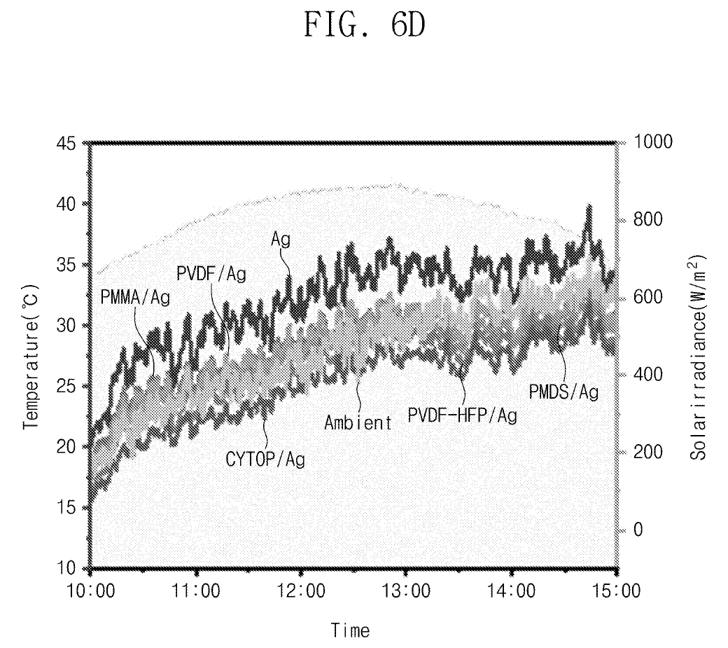

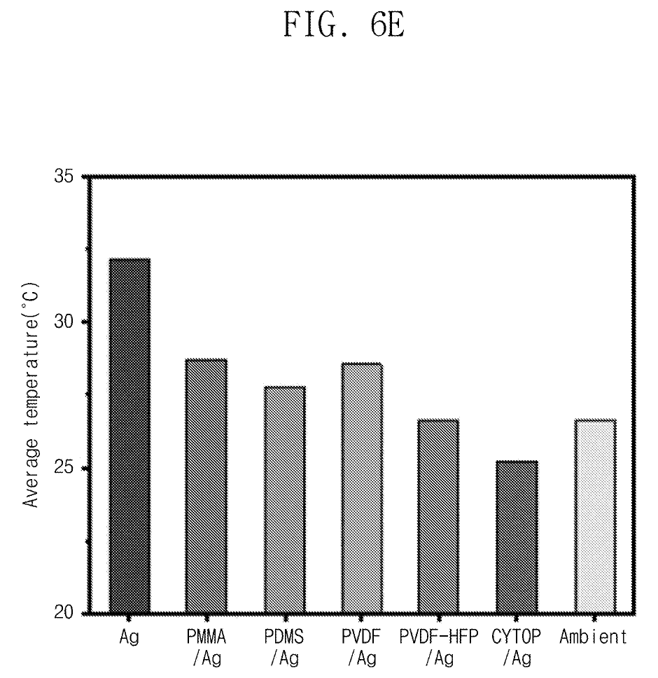

FIG. 6A is a graph showing the solar reflectance and the infrared emittance of the samples according to Example 2. Specifically, in the case of PDMS, the solar reflectance was 95.5% and the infrared emittance was 92%. In the case of PMMA, the solar reflectance was 94.0% and the infrared emittance was 89.5%. In the case of PVDF, the solar reflectance was 95.7% and the infrared emittance was 84.1%. In the case of PVDF-HFP, the solar reflectance was 96.0% and the infrared emittance was 93.6%. In the case of CYTOP, the solar reflectance was 96.3% and the infrared emittance was 91.3%. It can be seen that the samples M have solar reflectance of 94% or greater, and infrared thermal emissivity of 80% or greater, which are all high.

As a result, it can be interpreted that like the sample M according to Example 1, the samples M according FIG. 5 also reflect the light P incident inside the chamber CH and that the thermal energy emission by radiation is large.

### Experimental Example 7

FIG. 6B is a graph showing the theoretical cooling performance of the samples of the inventive concept. Referring to FIG. 6A, the theoretical maximum radiative cooling performance of each of the samples M including the polymers was calculated. As a result, the radiative cooling performance was calculated higher in the order of CYTOP(83.7W/m²), PVDF-HFP(80.6W/m²), PDMS(74.9W/m²), PVDF(67.6W/m²), and PMMA(58.7W/m²).

### Experimental Example 8

FIG. 6C is a graph showing the difference between the surface temperature of the samples of the inventive concept and the ambient temperature of the samples. Like in Experimental Example 2, the sample M according to Example 2 was fixed on the sample substrate Sub1 of the sample arrangement unit SPR. Thereafter, the sample arrangement unit SPR was periodically irradiated with light three times through the optical inlet H, and when a thermal equilibrium state in which the surface temperature of the sample M was maintained constant was reached, a difference ΔT between the surface temperature and the ambient temperature of the sample M were measured. The measurement was performed for a total of 6 times, and average values of the temperature differences ΔT are shown in FIG. 6C. As a result, the temperature differences were calculated smaller in the order of CYTOP(-0.5 °C), PVDF-HFP(-0.27 °C), PDMS(0.03 °C), PVDF(0.93 °C), and PMMA(1.13 °C). Referring to FIGS. 6B and 6C together, it can be confirmed that the average values of the temperature differences ΔT show a tendency consistent with the theoretical radiative cooling performance.

### Experimental Example 9

FIG. 6D is a graph showing the surface temperature of the samples according to Example 2 measured in an outdoor environment. Referring to FIG. 6D, it can be confirmed that the surface temperature of the samples M including the polymers is lower than the surface temperature of the sample M including the silver (Ag) mirror. As a result, it can be confirmed that when a polymer is used to prepare the sample M, it may lead to a cooling effect. Furthermore, it can also be seen that the samples M of the inventive concept change together as the ambient temperature changes over time.

### Experimental Example 10

FIG. 6E is a graph showing average values of the temperature of the samples in an outdoor environment. Referring to FIG. 6E, the average temperature of the surface temperature of the samples M measured for 5 hours during the day can be confirmed. It can again be confirmed that the surface temperature of the samples M including the polymers is lower than the surface temperature of the sample M including only the silver (Ag) mirror. In addition, referring to FIG. 6B and FIG. 6E together, it can be confirmed that the radiative cooling performance of the samples M including the polymers show a tendency consistent with the theoretical radiative cooling performance. As a result, the radiative cooling performance of the sample according to the inventive concept has a tendency consistent with the theoretical radiative cooling performance and the radiative cooling performance in an outdoor environment, and thus, may be used as a standard measuring device for evaluating the performance of a radiative cooling material.

In another experimental example, it is possible to prepare a sample M of a paint type, as well as a film type and a polymer-based type. The radiative cooling performance measuring device of the inventive concept has high reproducibility and versatility, and thus may be used as a measuring device for confirming the radiative cooling performance of a radiative cooling film, paint, fiber and the like as the sample M.

A radiative cooling performance measuring device according to the inventive concept may include films between a sample arrangement unit and a chamber having a hemispherical profile. Compressed dry air may be provided through a gas injection unit connected to a region between the films to prevent a problem of light irradiation obstruction caused by condensation on the surface of the film. The temperature of the provided compressed dry air may be adjusted to adjust the temperature of the sample arrangement unit.

Furthermore, the radiative cooling performance measuring device may be easily manufactured by 3D printing. A cooling material of the chamber includes dry ice and isopropyl alcohol, which are relatively easy to obtain, and thus may be easy to prepare, and may also be convenient to store and handle. As a result, it is possible to provide a radiative cooling performance measuring device which is easy to manufacture and has improved radiative cooling performance evaluation characteristics.

Although the embodiments of the inventive concept have been described with reference to the accompanying drawings, those skilled in the art will understand that the inventive concept can be implemented in other specific forms without changing the technical spirit or essential features thereof. It is therefore to be understood that the above-described embodiments are illustrative in all aspects and not restrictive.

What is claimed is:

1. A radiative cooling performance measuring device comprising:
an insulation unit including a sample arrangement unit;
a chamber on the sample arrangement unit;
films interposed between the sample arrangement unit and the chamber; and
a first gas injection unit connected to a region between the films,
wherein:
an inner wall of the chamber has a hemispherical profile; and
compressed dry air is provided to the region between the films through the first gas injection unit.

2. The radiative cooling performance measuring device of claim 1, further comprising a cooling material provided between the inner wall and an outer wall of the chamber,
wherein the cooling material includes dry ice and isopropyl alcohol.

3. The radiative cooling performance measuring device of claim 1, wherein a temperature of the sample arrangement unit is adjusted according to a temperature of the compressed dry air.

4. The radiative cooling performance measuring device of claim 1, further comprising a second gas injection unit between the chamber and an uppermost film among the films,
wherein compressed dry air is provided to the region between the uppermost film and the chamber through the second gas injection unit.

5. The radiative cooling performance measuring device of claim 1, wherein the chamber further comprises an optical inlet, and
wherein light entering through the optical inlet is incident on the sample arrangement unit.

6. The radiative cooling performance measuring device of claim 1, wherein:
the insulation unit surrounds the chamber; and
the insulation unit includes an insulation material.

7. The radiative cooling performance measuring device of claim 1, further comprising:
a sample substrate provided on the sample arrangement unit, and a sample on the sample substrate; and
a thermocouple provided on a bottom surface of the substrate.

8. The radiative cooling performance measuring device of claim 7, wherein the sample comprises a silver mirror on the substrate.

9. The radiative cooling performance measuring device of claim 8, wherein the sample further comprises a polymer on the silver mirror.

10. The radiative cooling performance measuring device of claim 7, wherein a temperature of the sample arrangement unit is measured using the sample.

11. A radiative cooling performance measuring device comprising:
an insulation unit including a sample arrangement unit;
a chamber on the sample arrangement unit;
films interposed between the sample arrangement unit and the chamber; and
a first gas injection unit connected to a region between the films,
wherein:
an inner wall of the chamber has a hemispherical profile; and
a cooling material provided between the inner wall and an outer wall of the chamber is further included, wherein the cooling material includes dry ice and isopropyl alcohol.

12. The radiative cooling performance measuring device of claim 11, wherein compressed dry air is provided to the region between the films through the first gas injection unit, and
wherein a temperature of the sample arrangement unit is adjusted according to a temperature of the compressed dry air.

13. The radiative cooling performance measuring device of claim 11, further comprising a second gas injection unit between the chamber and an uppermost film among the films,
wherein compressed dry air is provided to the region between the uppermost film and the chamber through the second gas injection unit.

14. The radiative cooling performance measuring device of claim 11, further comprising a sample substrate provided on the sample arrangement unit, and a sample on the sample substrate,
wherein the sample includes a silver mirror on the sample substrate.

15. The radiative cooling performance measuring device of claim 14, wherein the sample further comprises a polymer on the silver mirror.

16. The radiative cooling performance measuring device of claim 14, wherein a temperature of the sample arrangement unit is measured using the sample.
